(19) United States
(12) Patent Application Publication
(10) Pub. No.: US 2014/0214731 A1
(43) Pub. Date: Jul. 31, 2014

(54) Method and System for Automated Computer Program Generation

(71) Applicants: Nicola Vincent Granny, Bloomington, IN (US); Martina Maria Barnas, Bloomington, IN (US); Clinton Wylie, Bloomington, IN (US)

(72) Inventors: Nicola Vincent Granny, Bloomington, IN (US); Martina Maria Barnas, Bloomington, IN (US); Clinton Wylie, Bloomington, IN (US)

(73) Assignee: MNB Technologies, Inc., Bloomington, IN (US)

(21) Appl. No.: 13/675,050

(22) Filed: Nov. 13, 2012

(51) Int. Cl. G06N 5/02; G06F 3/0483; G06F 3/0484

(52) U.S. Cl. CPC G06N 5/022; G06F 3/04842; G06F 3/0483
USPC 706/11

(57) ABSTRACT

A computer program making use of an expert system, novel user interface, a knowledge repository, and a relational database to automate the creation and customization of new computer programs and/or electronic system designs.

### STATEMENT REGARDING FEDERALLY SPONSORED RESEARCH OR DEVELOPMENT

This invention was made with government funding support under United States Government Contract FA9550-09-C-0070, awarded by the United States Air Force Office of Scientific Research (AFOSR). The Government has certain rights in this invention.

### CROSS-REFERENCE TO RELATED APPLICATIONS

Not Applicable

### REFERENCE TO SEQUENCE LISTING, A TABLE, OR A COMPUTER PROGRAM LISTING COMPACT DISK APPENDIX

Listing 1 (Attached CD ROM) is an ASCII text listing of the Design Database SQL schema script.

### BACKGROUND OF THE INVENTION

1. Field of the Invention

This invention relates generally to the field of computer sciences. More specifically the invention relates the practice of developing computer programs. Still more specifically, it relates to methods where individuals not particularly skilled in any specific computer programming language or formal computer software design practice may create computer program with the support of an expert system, itself a type of computer program. Further, this invention relates to the related field of Electronic Design Automation in that it may be used to develop the software necessary for design of electronic circuits and post-manufacture programmable electronic devices.

2. Prior Art
It is generally accepted that a computer is an electronic device for storing and processing data according to instructions given to it by way of a variable program.
Historically, development of the program used by a computer requires the use of one or more formally defined computer programming languages for which either a suitable compiler, interpreter, or synthesis tool is available.
The individual or team responsible for programming the computer must be skilled in the use of one or more computer programming languages or electronic design tool languages.
The computer program designed and developed using the programming language(s) is a detailed collection of statements and expressions that specify exactly how to perform all of the necessary operations.
The most common way to prepare a computer program is for the programmer to manually enter the program statements by way of a text-based human interface such as a keyboard or touchpad.
An alternative method to create a computer program is to make use of a Visual language which makes use of graphical or iconic elements which the user manipulates on a graphics display instead of using a text-based editor.

3. Claimed Date of Invention

The inventors conceived of the current invention and actively began work upon its embodiment on Jan. 14, 2007.

### SUMMARY OF THE INVENTION

The use of specialized terms in this specification is unavoidable, even in the summary. Therefore a brief list of certain key specialized terms is presented here:
Application
The body of computer program source code needed to produce an operational computer program and/or the body of hardware description language source code needed to produce an operational electronic design. The term is also used to define the top level of a hierarchal design.
Artificial Intelligence
The apparent intelligence of machines and the branch of computer science that aims to create it.
Expert System
A computer system or software that emulates the decision-making ability of one or more human experts. An expert system is generally composed of two key parts: 1) an Inference Engine, and 2) a Knowledge Base.
Item Description
Used generically herein, an item description is a collection of files that fully describe a single Model, Platform, or Target (terms described below).
Model
A description of the structure, interface, data requirements, and behavior of a specified object expressed in one or more programming or design language(s) similar to an algorithm or service. Examples include but are not limited to: a Matrix Multiplier, a Fast Fourier Transform, a Parsing Engine, a User Interface, etc.
Platform
A description of the structure, interface, data requirement, and behavior of a single specified application execution platform. Examples include but are not limited to: an FPGA, a microprocessor, or a Graphics Processing Unit (GPU).
Target
A description of a collection of “Platforms” including their physical wiring, support electronics, interface, and requirements that form the execution (run) environment both physical and logical, to be used by an application. Examples include but are not limited to: a desktop personal computer, an FPGA-based accelerator board, and/or a compute cluster.
Target Language
The particular computer program source code or electronic design language to be used for creation of the Application. Examples include, but are not limited to: C, C++, C#, Visual Basic, FORTRAN, ADA, Java, Verilog, VHDL, RUBY, Python, Perl, TCL, etc.

The current invention is a method and system that automates generation of a computer program or electronic design; an Application. Of particular interest is that by using the current invention the person(s) using the invention (hereafter “User”) does not require specific knowledge or expertise in computer programming, electronic design, or the underlying execution technology used by the Target or its component Platform(s). The key advantages of the invention in comparison to contemporary practice is: 1) a significant reduction in the time required to create a new Application, 2) a substantial reduction in the cost of creating a new Application, 3) a considerable reduction in the direct involvement of technical specialists in the development of a new Application, 4) improved utilization of technical specialists, 5) improved reuse of intellectual property, and 6) expansion of the pool of application domain experts that may reasonably craft their own Applications.

The current invention includes a plurality of principal components: 1) a specialized Graphical User Interface (GUI) that emulates the behavior and operation of a typical whiteboard and is herein referred to as the “Virtual Whiteboard” and emulates the behavior and use of typical sticky notes and is referred herein as “Virtual Sticky Notes”, 2) a high performance relational database to contain the User's design and component Target, Platforms, and Models referred to herein as the “Design Database”, 3) a proprietary (trade secret) Inference Engine, 4) both centralized and distributed Knowledge Bases referred to herein as “Repositories”, and 5) a specialized knowledge engineering propositional language and ontology collectively referred to herein as “Expression Language”.

In operation the User, by way of the Virtual Whiteboard and Virtual Sticky Notes, graphically (visually) described the desired architecture and behavior of the Application by spatially positioning avatars of the Models to be used and connecting them with “Edges” which define data flows. The User then searches available Repositories and downloads the desired Target, Platform, and Model description files from them and adds them to the Design Database. These downloaded Item Descriptions contains the facts, rules, assertions, code fragments, source code files, scripts, and other information needed by the Inference Engine to implement the Users Application.

With the Design Database populated the User commands the Inference Engine to begin its internal inference process. During inference the Inference Engine uses the Design Database as both the problem description (the description of the problem it is seeking to resolve, in this case crafting an Application) and as the Knowledge Base.

After successfully completing the inference process a collection of Target Language files will have been produced that represent the implementation of the Application. These implementation files are then passed-on to conventional compilation and synthesis tools for reduction to one or more executable program(s) for the Target.

### BRIEF DESCRIPTION OF THE DRAWINGS

FIG. 1 is a high-level schematic representation of the overall system.

FIG. 2 is a detailed block diagram of the Knowledge Repository.

FIG. 3 is a schematic representation of the Item Description.

FIG. 4 (five pages) is a collection of User Interface screen shots.

FIG. 5 is a flow chart of the inference process.

### BRIEF DESCRIPTION OF ATTACHED COMPUTER PROGRAM LISTING

Listing 1 is an ASCII text listing of the Design Database SQL schema script.

### DETAILED DESCRIPTION OF THE INVENTION

Overall Knowledge and Process Flow in the Invention

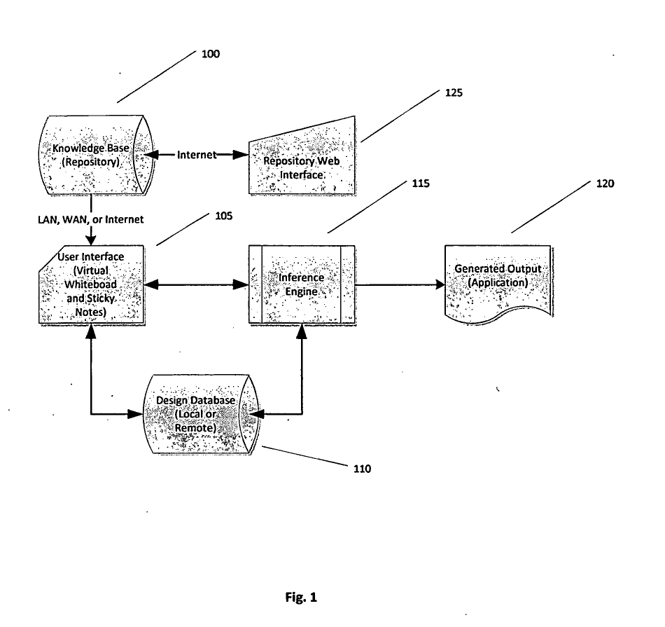

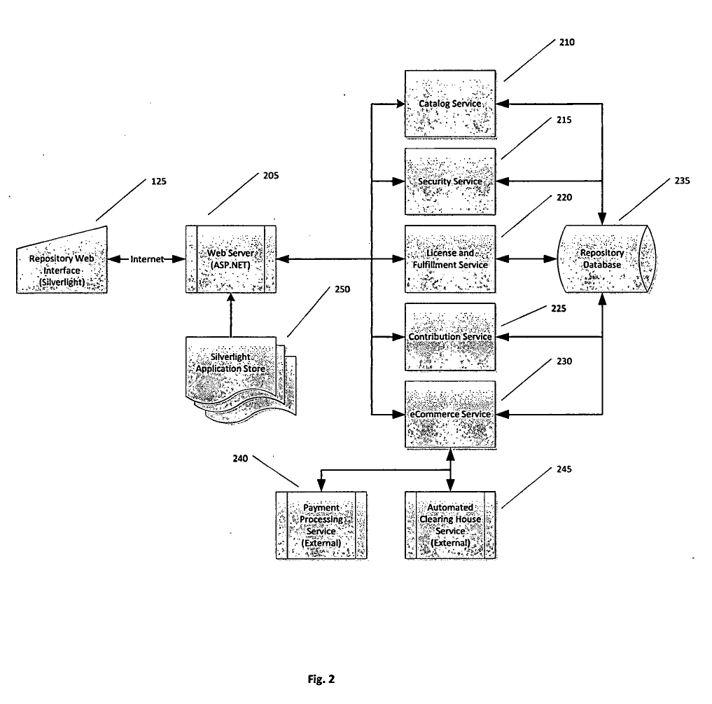

Referring to FIG. 1, the current invention is an automated system that enables a User with no particular expertise in computer programming, electronic design, or their implementation languages to create an application program targeting both conventional and mixed-technology execution platforms. In this context the term mixed-technology implies a combination of execution platform technologies that includes, but is not limited to: single and multi-core microprocessors, FPGAs, GPUs, compute clusters, or compute clouds.

Knowledge and expertise of human subject matter experts (computer programmers, electronic design engineers, etc) is captured using Item Descriptions and is persisted in the Knowledge Base (100) for subsequent use by a plurality of system Users. This capture knowledge includes functional and behavioral descriptions of Targets, Platforms, and Models including implementation source code fragments, scripts, and library source files needed to implement the specific item in the Application.

The invention's User starts the User Interface (105) to access its Virtual Whiteboard and Virtual Sticky Notes capabilities. The User visually defines the desired architecture using the Virtual Whiteboard and identifies each architectural element by behavior. The User then interrogates the Knowledge Base (100) and downloads the required Item Descriptions installing them in the Design Database (110). Again using the User Interface (105) customization parameters are attached to each architectural element using Virtual Sticky Notes.

Once the architecture is fully defined the User starts the Inference Engine (115) by selecting the “Build” command from the User Interface (105). The Inference Engine (115) descends through the hierarchal Design Database selecting suitable implementation candidates from the collection of Item Descriptions installed in the Design Database and processes the selected candidates to create the desired Generated Output (120). The inference process is more fully described later in this specification.

A plurality of Item Description contributors provides both Open Source and/or proprietary Item Descriptions to the Repository (100) by using the Repository Web Interface (125). These Item Descriptions are more fully described later in this specification.

Detailed Description of the Knowledge Base (Repository)

Referring now to FIG. 2, the User (or Contributor) accesses the Repository through a Silverlight enabled web browser, the Repository Web Interface (125). The Web Server (205) then provides the appropriate Silverlight application pages from its Application Store (250). As the user requests various services the Web Server (205) dispatches the request(s) to the appropriate service provider (210 . . . 230). The principal services (210 . . . 230) communicate with the Repository Database (235) to execute appropriate SQL queries.

Repository Services

The following principal services are provided by the Repository and communicate with the Repository Database (235):
Catalog Service (210)
The Catalog Service provides the User with the ability to perform both simple and complex searches of the Repository contents by querying the metadata (data about data) for each Repository entry.
Security Services (215)
The Security Services provide User registration, log-in, log-out, and data transfer cryptographic services.
License and Fulfillment Service (220)
This service is used to both validate Item Description and system licenses in the User's possession and the issuance of new Item Description licenses.
Contribution Services (225)
This service manages the Item Description contribution process.
eCommerce Service (230)
This service manages the Item Description purchase transactions between the User and the Repository. This service also manages integration with the external Payment Processing Service (240) and the Automated Clearing House (ACH) Service (245) that issues payments to the Item Description contributors when one of their contributions is purchased by a User.

Item Description Files

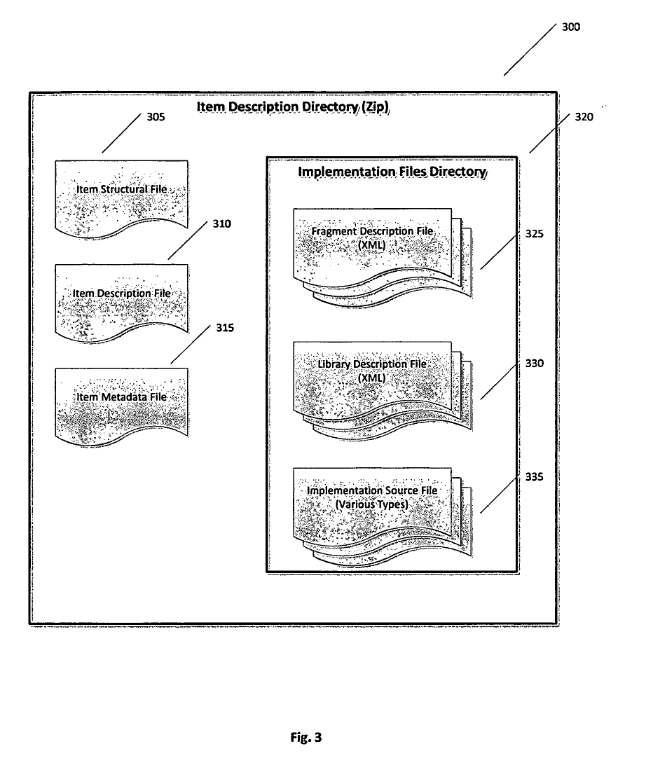

Refer now to FIG. 3. Item Description Files are persisted in the form of a compressed (zipped) and encrypted Item Description Directory (300). Contained within this directory are three files (305 . . . 315) and another directory (320). The three top-level files are:
Item Structural File (305)
This XML formatted file contains the structural information needed to render symbol of the file within the User Interface (FIG. 1, Item 105). This information includes the shape name, shape dimensions, shape location, item instance name, and certain behavioral data.
Item Description File (310)
Also an XML formatted file it contains rules, facts, and assertions that are common to all components of this item that are needed by the Expert System to either select or de-select this item during inference.
Item Metadata File (315)
Another XML formatted file it concerns item identification data, and an assortment of data concerning the items fit/form/function that is used to correctly catalog the item and issue licenses for the item.

The Implementation Files Directory (320) contains the various files that the Expert System exports and modifies in order to generate output for the Application. The sets of files included in this directory are:
Fragment Description Files (325)
Fragment description files are collections of code fragments that may be exported, inserted into the output is specified locations, and customized by the Expert System during the export. Typically a fragment description file will generate a single target language source file.
Library Description Files (330)
Library Description Files are complete files that are exported and customized by the Expert System during inference but are complete source files and are not assembled from multiple fragments.
Implementation Source Files (335)
These are target language source code files that are exported by the Expert System during inference but are not customized during export—they are used as-is. These are not only target language source files but may also be scripts executed by the Inference Engine to calculate replaceable parameters or generate output text. The implementation source files also include small computer programs, called scripts, written in a conventional programming language, that are executed during inference to assist the expert system in customizing output code.

Item Structural File (305) Schema

<?xml version=“1.0” encoding=“Windows-1252”?>
<xs:schema xmlns:xsi=“http://www.w3.org/2001/XMLSchema-
instance” xmlns:xsd=“http://www.w3.org/2001/XMLSchema” xmlns:xs=“http://www.w3.org/2001/XMLSch
ema” attributeFormDefault=“unqualified” elementFormDefault=“qualified”>

<xsd:element name=“ModelStructuralFile”>

<xsd:complexType>

<xsd:sequence>

<xsd:element name=“Model”>

<xsd:complexType>

<xsd:sequence>

<xsd:element name=“Date” type=“xsd:dateTime” />
<xsd:element name=“ModelInstances” />
<xsd:element name=“ModelImplementations”>

<xsd:complexType>

<xsd:sequence>

<xsd:element name=“ModelDescriptionFile-ref”>

<xsd:complexType>

<xsd:attribute name=“RelativePath” type=“xsd:string” use=“required” />
<xsd:attribute name=“ModelImplementationId” type=“xsd:string”

use=“required” />

</xsd:complexType>

</xsd:element>

</xsd:sequence>

</xsd:complexType>

</xsd:element>
<xsd:element name=“UserConfigurableSettings” />
<xsd:element name=“InputPorts” />
<xsd:element name=“OutputPorts” />
<xsd:element name=“InOutPorts” />
<xsd:element name=“Edges” />
<xsd:element name=“VisualLayout”>

<xsd:complexType>

<xsd:sequence>

<xsd:element name=“NodeLayout” />

</xsd:sequence>

</xsd:complexType>

</xsd:element>

</xsd:sequence>
<xsd:attribute name=“Id” type=“xsd:string” use=“required” />
<xsd:attribute name=“Name” type=“xsd:string” use=“required” />
<xsd:attribute name=“Version” type=“xsd:string” use=“required” />
<xsd:attribute name=“Type” type=“xsd:string” use=“required” />
<xsd:attribute name=“Stages” type=“xsd:unsignedByte” use=“required” />
<xsd:attribute name=“FunctionList” type=“xsd:string” use=“required” />

</xsd:complexType>

</xsd:element>

</xsd:sequence>

</xsd:complexType>

</xsd:element>

</xs:schema>

Item Description File (310) Schema

<?xml version=“1.0” encoding=“Windows-1252”?>
<xs:schema xmlns:xsi=“http://www.w3.org/2001/XMLSchema-
instance” xmlns:xsd=“http://www.w3.org/2001/XMLSchema” xmlns:xs=“http://www.w3.org/2001/XMLSch
ema” attributeFormDefault=“unqualified” elementFormDefault=“qualified”>

<xsd:element name=“ModelDescriptionFile”>

<xsd:complexType>

<xsd:sequence>

<xsd:element name=“ModelDescription”>

<xsd:complexType>

<xsd:sequence>

<xsd:element name=“Date” type=“xsd:dateTime” />
<xsd:element name=“LocalVariables”>

<xsd:complexType>

<xsd:sequence>

<xsd:element maxOccurs=“unbounded” name=“Fact” type=“xsd:string” />

</xsd:sequence>

</xsd:complexType>

</xsd:element>
<xsd:element name=“ConsumedInventory” />
<xsd:element name=“Requires” />
<xsd:element name=“Assertions” />
<xsd:element name=“Ratings” />
<xsd:element name=“FragmentOutputFiles”>

<xsd:complexType>

<xsd:sequence>

<xsd:element maxOccurs=“unbounded” name=“OutputFile-ref”>

<xsd:complexType>

<xsd:attribute name=“RelativePath” type=“xsd:string” use=“required” />

</xsd:complexType>

</xsd:element>

</xsd:sequence>

</xsd:complexType>

</xsd:element>
<xsd:element name=“LibraryOutputFiles”>

<xsd:complexType>

<xsd:sequence>

<xsd:element maxOccurs=“unbounded” name=“OutputFile-ref”>

<xsd:complexType>

<xsd:attribute name=“RelativePath” type=“xsd:string” use=“required” />

</xsd:complexType>

</xsd:element>

</xsd:sequence>

</xsd:complexType>

</xsd:element>

</xsd:sequence>
<xsd:attribute name=“Id” type=“xsd:string” use=“required” />
<xsd:attribute name=“Name” type=“xsd:string” use=“required” />
<xsd:attribute name=“Version” type=“xsd:string” use=“required” />
<xsd:attribute name=“Type” type=“xsd:string” use=“required” />
<xsd:attribute name=“ImplementationFor” type=“xsd:string” use=“required” />
<xsd:attribute name=“ModelName” type=“xsd:string” use=“required” />

</xsd:complexType>

</xsd:element>

</xsd:sequence>

</xsd:complexType>

</xsd:element>

</xs:schema>

Item Metadata File (315) Schema

<?xml version=“1.0” encoding=“Windows-1252”?>
<xs:schema xmlns:xsi=“http://www.w3.org/2001/XMLSchema-
instance” xmlns:xsd=“http://www.w3.org/2001/XMLSchema” xmlns:xs=“http://www.w3.org/2001/XMLSch
ema” attributeFormDefault=“unqualified” elementFormDefault=“qualified”>

<xsd:element name=“PackageMetadata”>

<xsd:complexType>

<xsd:sequence>

<xsd:element name=“MetaId” nillable=“true” />
<xsd:element name=“Description” type=“xsd:string” />
<xsd:element name=“Tags” />
<xsd:element name=“Categories” />
<xsd:element name=“OwnershipContactData” >

<xsd:complexType>

<xsd:sequence>

<xsd:element name=“ResponsibleContacts” />
<xsd:element name=“AccountableContacts” />
<xsd:element name=“ConsultContacts” />
<xsd:element name=“InformContacts” />

</xsd:sequence>

</xsd:complexType>

</xsd:element>

</xsd:sequence>

</xsd:complexType>

</xsd:element>

</xs:schema>

Fragment Description File (325) Schema

<?xml version=“1.0” encoding=“Windows-1252”?>
<xs:schema xmlns:xsi=“http://www.w3.org/2001/XMLSchema-
instance” xmlns:xsd=“http://www.w3.org/2001/XMLSchema” xmlns:xs=“http://www.w3.org/2001/XMLSch
ema” attributeFormDefault=“unqualified” elementFormDefault=“qualified”>

<xsd:element name=“LibraryOutputFileDescriptionFile”>

<xsd:complexType>

<xsd:sequence>

<xsd:element name=“LibraryOutputFileDescription”>

<xsd:complexType>

<xsd:sequence>

<xsd:element name=“ImplementationId” type=“xsd:string” />
<xsd:element natne=“FileName” type=“xsd:string” />
<xsd:element name=“FileType”>

<xsd:complexType>

<xsd:attribute name=“TypeName” type=“xsd:string” use=“required” />
<xsd:attribute name=“Extension” type=“xsd:string” use=“required” />

</xsd:complexType>

</xsd:element>
<xsd:element name=“ConsumedInventory” />
<xsd:element name=“Requires” />
<xsd:element name=“Assertions” />
<xsd:element name=“IsHumanReadable” type=“xsd:boolean” />

</xsd:sequence>
<xsd:attribute name=“FilePath” type=“xsd:string” use=“required” />

</xsd:complexType>

</xsd:element>

</xsd:sequence>

</xsd:complexType>

</xsd:element>

</xs:schema>

Library Description File (330) Schema

<?xml version=“1.0” encoding=“Windows-1252”?>
<xs:schema xmlns:xsi=“http://www.w3.org/2061/XMLSchema-
instance” xmlns:xsd=“http://www.w3.org/2001/XMLSchema” xmlns:xs=“http://www.w3.org/2001/XMLSch
ema” attributeFormDefault=“ unqualified” element FormDefault=“qualified”>

<xsd:element name=“LibraryOutputFileDescriptionFile”>

<xsd:complexType>

<xsd:sequence>

<xsd:element natne=“LibraryOutputFileDescription”>

<xsd:complexType>

<xsd:sequence>

<xsd:element name=“ImplementationId” type=“xsd:string” />
<xsd:element name=“FileName” type=“xsd:string” />
<xsd:element name=“FileType”>

<xsd:complexType>

<xsd:attribute name=“TypeName” type=“xsd: string” use=“required” />
<xsd:attribute name=“Extension” type=“xsd:string” use=“required” />

</xsd:complexType>

</xsd:element>
<xsd:element name=“ConsumedInventory” />
<xsd:element name=“Requires” />
<xsd:element name=“Assertions” />
<xsd:element name=“IsHumanReadable” type=“xsd:boolean” />

</xsd:sequence>
<xsd:attribute name=“FilePath” type=“xsd: string” use=“required” />

</xsd:complexType>

</xsd:element>

</xsd:sequence>

</xsd:complexType>

</xsd:element>

</xs:schema>

Detailed Description of the User Interface

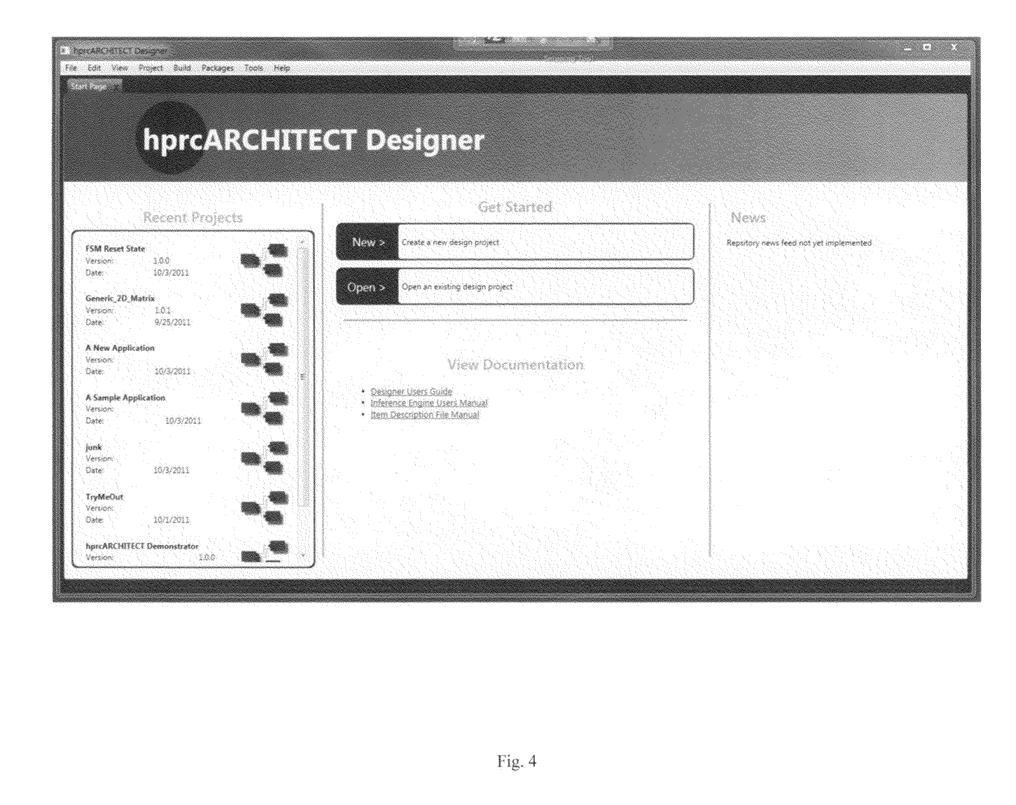

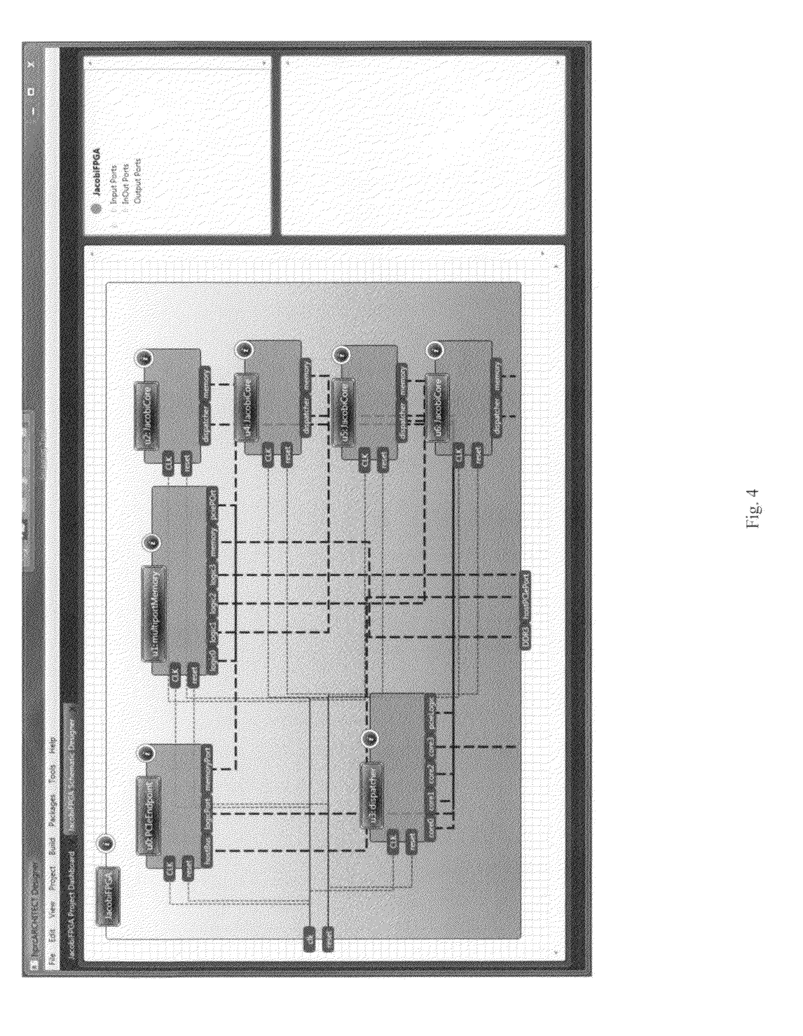

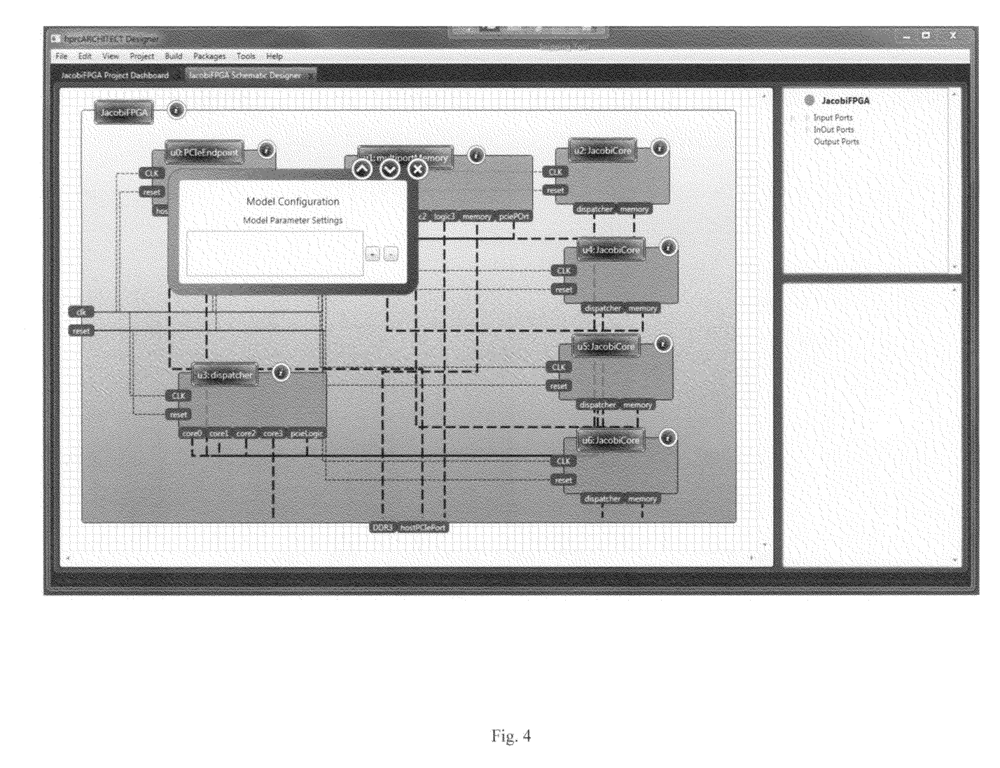

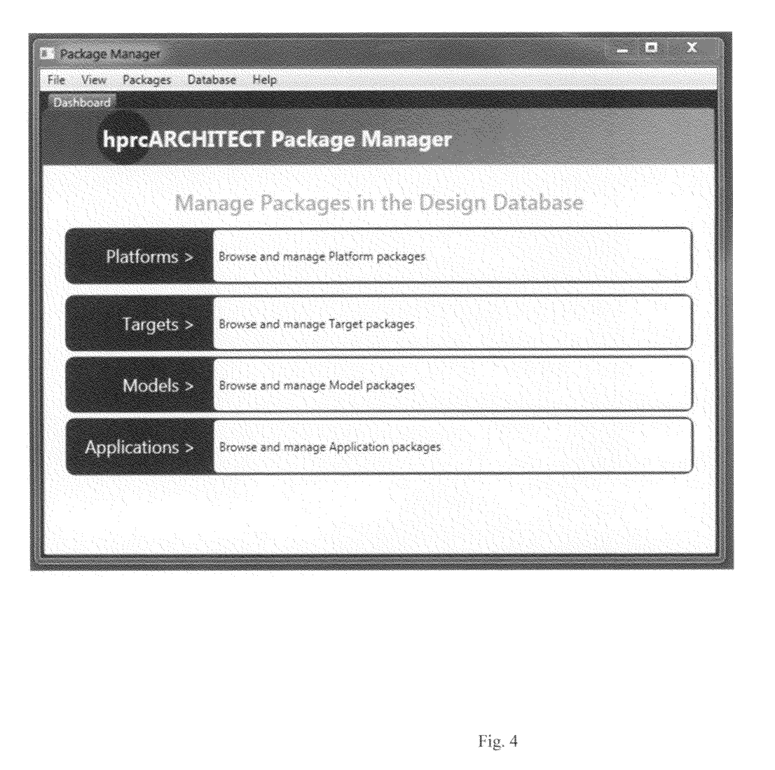

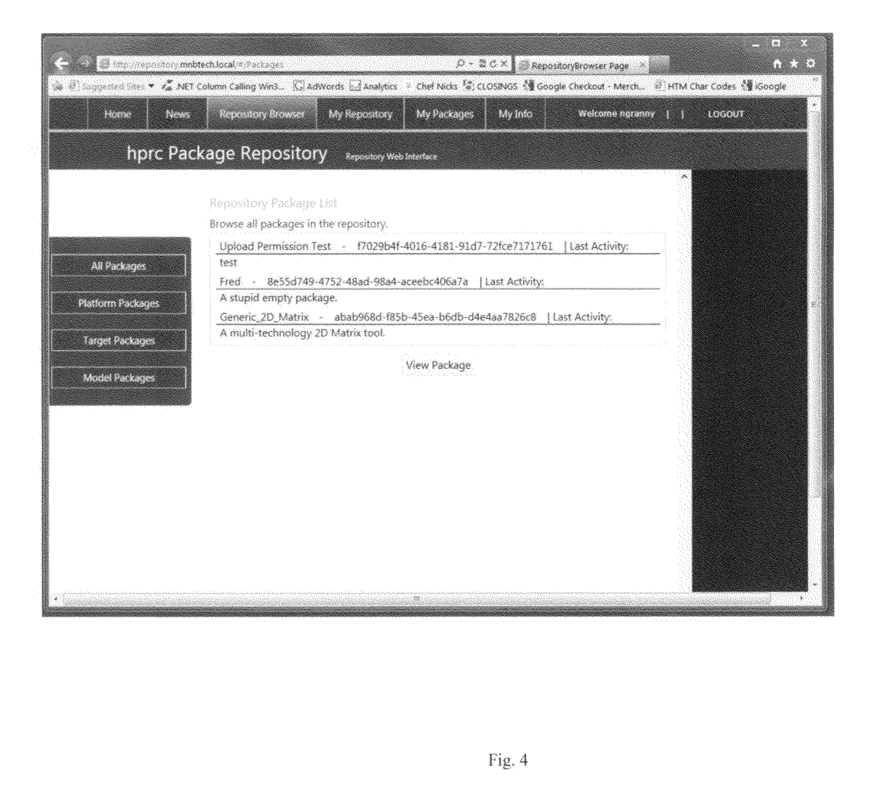

Referring to FIG. 4 page 1, the opening page of the User Interface is shown. In the right pane the User is provided with a listing of recently opened projects. The center pane provides access to creating a new project or opening an existing project, and on-line access to the product documentation. A conventional Windows® style pull-down menu strip is provided at the top of the User Interface to access less frequently used tools.

Referring now to FIG. 4 page 2, the Virtual Whiteboard is shown with a number of connected architecture elements in the workspace. The User can add a new element by right-clicking anywhere on the workspace. Further, the User can open the model for a displayed architecture element by right-clicking the element. Clicking the i emblem invokes the Virtual Sticky Notes feature of the User Interface.

Refer to FIG. 4 page 3. The User Interface is shown with the Virtual Sticky Note open and ready for User input.

In FIG. 4 page 4 the User Interface to the Design Database package manager is shown. From this interface the User may add, modify, or remove Item Descriptions for Platforms, Targets, Models, and Applications. This provides a convenient tool for design database management without having to open a project in the Virtual Whiteboard.

Refer now to FIG. 4 page 5 for a view of the Repository Web Interface (reference FIG. 1 item 125). This web interface enables a User to search or browse the Repository, retrieve an Item from the Repository or contribute a new Item to the Repository. This interface also allows a special class of User called a “Moderator” to approve new contributions for publication or send them back to the contributor for revision. This is also the portal to the eCommerce services that enable Users to purchase proprietary (licensed) Items from the Repository.

Detailed Description of the Inference Process

In computer science, and more specifically artificial intelligence, an inference engine is a computer program that derives a solution to a presented problem from a knowledge base. It is the “brain” that expert systems use to emulate the decision making process of human subject matter experts. Inference engines are considered to be a domain-specific special case of reasoning engines, which often use more general methods of reasoning.

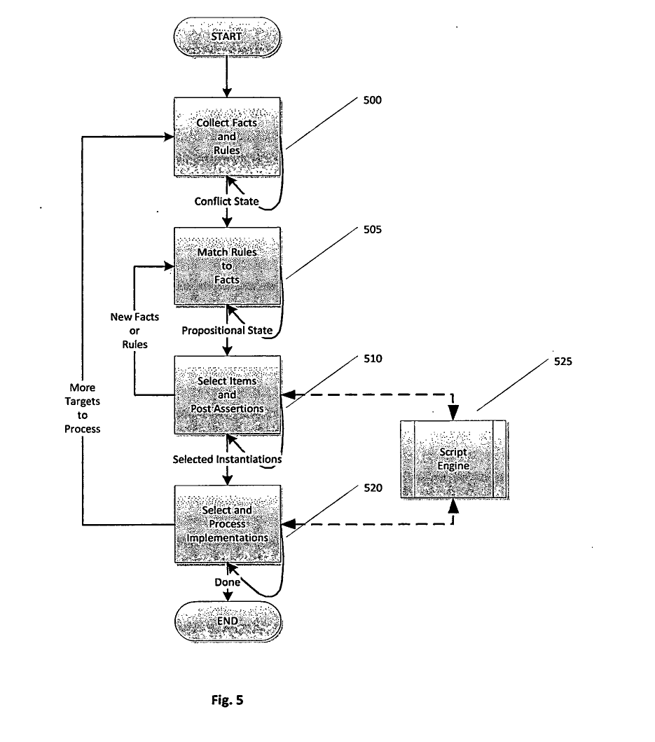

Referring to FIG. 5, the Inference Engine is a Finite State Machine with four primary states, each of which being recursive. In the Collect Facts and Rules State (500) the system descends through the Design Database (FIG. 1, item 110) collecting and cataloging all of the facts and rules found in the Item Descriptions as well as instance specific facts and rules introduced by the User during architecture definition. After all Facts and Rules have been collected and cataloged the totality is presented to the next state as the “Conflict State”.

The Conflict State is processed by the Match Rules to Facts state (505). In this state the suitability of available implementation candidates is evaluated and where Rules and Facts match one or more Assertions are generated and added to the “Propositional State”.

The Propositional State is evaluated by the Select Items and Post Assertions state (510). In this state the system compares the elements of the Propositional State to the selection rules of the individual Item selection tags. Each selected item is assigned a quality score and after all candidates for a specific item have been evaluated an Assertion to use a specific implementation is posted as a new Assertion by adding it to the Selected Instantiations list.

Selected Instantiations are then processed by the Select and Process Implementations State (520) which generates the desired target language outputs. If additional Targets must be processed then the state machine returns to Collect Facts and Rules (500).

A novel element of the invention's Inference Engine is a Script Engine (525) accessible by the final two stages of the inference process. This script engine is callable from the inventions specialized Expression Language. Expression Language is a declarative propositional language, described in detail later in this specification, used to define the propositional logic that instantiates rules, facts, and assertions. The Script Engine gives a high degree of conventional processing power to the Inference Engine and increasing the dynamic capabilities of the system to self-generate output code. The Script Engine uses the C# (C-Sharp) programming language and can access any of the .NET 4.0 (or newer) libraries.

Detailed Description of Expression Language

The Inference Expression Language (IEL) is a language of primitives with a simple syntax that allows fact and rule expressions to be constructed for the current invention design elements. To be evaluated, expressions are passed to the IEL Interpreter where they are analyzed and parsed. The Interpreter, written in F#, uses fslex and fsyacc for lexical analysis and parses with a LALR generated parser.

The IEL was designed to be familiar, simple, and light-weight. However, it is expressive enough to perform most of the needs of the Inference Engine.

Expressions

Expressions, in general, are any valid combination of symbols within a programming language that represents a value. Examples of these in the IEL are 3, foo, “str”, and baz=(foo+bar)/5.0. Every expression must have at least one operand, a value or variable, such as 3, or “str”, or baz. Expressions may also contain one or more operators such as =, +, or /. The IEL defines several expression types listed here.
Value
Variable
Assignment
Unary Operator
Binary Operator
If
Begin

In the sections that follow we will examine these types and learn how they are formatted. To avoid XML tagging, examples will be shown as if we are typing them into the Interactive IEL Interpreter.

Value Expressions

The IEL makes use of several value types, most of which should be familiar to you. Except for assignments, all expressions must eventually evaluate to one of these types. Assignments evaluate to null.

The table below lists the IEL type names, their syntax, shows examples, and describes their representation within the Interpreter. Note that List and Set expressions begin with a single quote ‘symbol and that their entries are separated with spaces, not with commas.

| | | | Internal |
|---|---|---|---|
| Type | Syntax | Example | Representation |
| Integer | <digits> | 2 | Int32 |
| Float | <digits>.<digits> | 2.0 | Double |
| String | ″<chars>″ | ″hello world″ | String |
| Boolean | true \|false | True | Boolean |
| List | ′(<expression> ...) | ′(″foo″ ″bar″) | F# list<Expression> |
| Set | ′{<expression> | ′{2.345 1.2} | F# Set<Expression> |
| | ...} | | |
| Null | Null | Null | F# unit |
| Struct | {<property> = | { Name = ″Bob″, | F# |
| | <expression>, ...} | Age=8} | Map<string,Expression> |
| Tensor | {<property> = | { Param = (“varName, 3, | F# |
| | (descriptor string} | 1.0f, ’ 16,8,32’”)} | Map<string,Expression> |

Variables Expressions

Every variable is the key to a value in a dictionary, a collection of variable-value pairs. Since variables are the identifier portion of fact expressions, all facts gathered by the current invention are stored by their identifiers that can be referenced by other expressions.

Referencing Struct Properties

Variables that reference structs can also reference the properties of the struct. For instance, if we define a struct

myStruct={prop1=“first”, prop2=“2nd”, prop3=“third”}

then we can reference the properties of myStruct like this:

value1=myStruct.prop1

value2=myStruct.prop2

and our list of facts will be:

[myStruct=map [(prop1, “first”); (prop2, “2nd”); (prop3, “third”)]]

[value1=“first”]

[value2=“2nd”]

Referencing List and Set Elements

In general you cannot reference elements of lists and sets in the IEL. One could argue whether referencing a particular element of a set makes sense since a set is an unordered data structure that prevents duplicates. With lists, the head and tail of a list can be referenced by the head and tail operators described in the Unary Operator Expressions section. If you needed, you could use a combination of these to pull out a particular element. For instance, if we define a list

myList=‘(1 2 3 6 10)

and we want the fourth element of the list, 6, we could use

six=head tail tail tail myList

then our collection of facts would be

[myList=[1; 2; 3; . . . ]]

[six=6]

Assignment Expressions

Assignment expressions are the expressions that create facts: they assign an expression to an identifier. When they are evaluated as facts by the current invention Inference Engine, they modify the inference state by adding their variable-value data to the collection of known Facts. However, an assignment expression can also be evaluated within another expression such as begin. When that occurs, they do not modify the inference state. Instead, the scope of the assignment is limited to the expression in which they are evaluated, e.g. begin. The syntax for assignment expressions has been discussed already, and is shown again in the table below.

| Syntax | Example |
|---|---|
| <identifier> <assignment-operator> <expression> | baz = (foo*bar) / 5.0 |

In addition to the simple assignment operator that can be used for any expression type. The IEL also implements assign-arithmetic operators such as +=for Float and Integer types. The table below gives their name, syntax, and operand types. The resultant type is always “Modified Inference Environment” which is rendered as null of Null in the IEL Terminal.

| Operation | Operator | Example | Operand Types | Result Type |
|---|---|---|---|---|
| Assign | = | foo = 3 | Any | Modified |
| | | | | Inference |
| | | | | Environment |
| Assign-Increment | += | foo += x | Integer, Float | Modified |
| | | | | Inference |
| | | | | Environment |
| Assign- | −= | foo −= y | Integer, Float | Modified |
| Decrement | | | | Inference |
| | | | | Environment |
| Assign-Multiply | *= | foo *= z | Integer, Float | Modified |
| | | | | Inference |
| | | | | Environment |
| Assign-Divide | /= | foo /= w | Integer, Float | Modified |
| | | | | Inference |
| | | | | Environment |

Binary Operator Expressions

Binary operator expressions use operators that require two operands (thus, binary). Depending on the operator, they can be written either using infix notation or using prefix notation. In infix notation, the operator is placed between the two operands. This is the standard notation of arithmetic. In prefix notation, the operator is placed before both of the operands, the way we would write a function of two variables. The table below illustrates the syntax and provides examples.

| Syntax | Example |
|---|---|
| <expression> <operator> <expression> | (((2 + 3) * 4)/2) > 5 |
| <operator> <expression> <expression> | union (intersect s1 s2)s3 |

Most of the binary operators defined in the IEL use infix notation. Remember to use parentheses liberally when handling them. Only the set operators and list operators use prefix notation in the IEL.

Arithmetic Operators

Arithmetic operators use infix notation. The table below gives their name, syntax, and operand types, and lists the possible result types. The notation “Integers→Integer” means that two Integer operands will yield an Integer result. And “Integer, Float→Float” means that if the first operand is an Integer and the second is a Float, the result will be a Float.

| | Oper- | Exam- | | Result |
|---|---|---|---|---|
| Operation | ator | ple | Operand Types | Type |
| Addition | + | 2 + 3 | Integer, Float, | Integers −> Integer |
| | | | String (append) | Integer, Float −> Float |
| | | | | Float, Integer −> Float |
| | | | | Floats −> Float |
| | | | | Strings −> String |
| Subtraction | − | 3 − 2 | Integer, Float | Integers −> Integer |
| | | | | Integer, Float −> Float |
| | | | | Float, Integer −> Float |
| | | | | Floats −> Float |
| Multipli- | * | 2 * 3 | Integer, Float | Integers −> Integer |
| cation | | | | Integer, Float −> Float |
| | | | | Float, Integer −> Float |
| | | | | Floats −> Float |
| Division | / | 3 / 2 | Integer, Float | Integers −> Integer |
| | | | | Integer, Float −> Float |
| | | | | Float, Integer −> Float |
| | | | | Floats −> Float |
| Modulo | % | 3 % 2 | Integer, Float | Integers −> Integer |
| | | | | Integer, Float −> Float |
| | | | | Float, Integer −> Float |
| | | | | Floats −> Float |

Comparison Operators

Comparison operators use infix notation in the IEL. The table below gives their name, syntax, and operand type. The result of all comparison operators is either True or False. Note that all value types can be compared using equality or inequality operations. However, only the magnitudes of Integer and Float variable types may be compared.

| | Oper- | Exam- | | Result |
|---|---|---|---|---|
| Operation | ator | ple | Operand Types | Type |
| Equality | == | a == “bob” | All | Bool |
| Inequality | != | a != false | All | Bool |
| Greater Than | > | x > 17 | Integer, Float | Bool |
| Less Than | < | x < 12 | Integer, Float | Bool |
| Greater Than or | >= | x >= 5 | Integer, Float | Bool |
| Equal | | | | |
| Less Than or Equal | <= | x <= 7 | Integer, Float | Bool |

Logical Operators

The logical operators logical-OR and logical-AND use infix notation and may be used to compare two Boolean values. They return Boolean values. The table below shows their syntax and provides examples.

| | Oper- | Exam- | | Result |
|---|---|---|---|---|
| Operation | ator | ple | Operand Types | Type |
| Logical And | && | (x != 3) && (y > 7) | Bool | Bool |
| Logical Or | \|\| | (m > 3) \|\| b | Bool | Bool |

Bitwise Operators

The IEL provides infix bitwise operators for Integer types. Note that the IEL only represents Integers in decimal format; it will not convert numbers written in binary, octal, hexadecimal, or any other numeral system to decimal notation automatically. Internally the IEL represents Integers in 32-bit, two's complement notation. In other words, ˜0=−1, etc. The table below lists the IEL bitwise operators and their syntax.

| | Oper- | Exam- | | Result |
|---|---|---|---|---|
| Operation | ator | ple | Operand Types | Type |
| Bitwise AND | & | x & y | Integer | Integer |
| Bitwise OR | \| | x \| y | Integer | Integer |
| Bitwise NAND | ~& | x ~& y | Integer | Integer |
| Bitwise NOR | ~\| | x ~\| y | Integer | Integer |
| Shift Left | << | x << 1 | Integer | Integer |
| Shift Right | >> | x >> 2 | Integer | Integer |

Contains Operator

The last infix notation binary operator that the IEL provides is contains. This operator determines if the string, list, or set operand on its left contains the operand on its right, which may be any expression that can exist in a string, list, or set. The result is either True or False. The table below gives the syntax for contains.

| | Oper- | Exam- | | Result |
|---|---|---|---|---|
| Operation | ator | ple | Operand Types | Type |
| Contains | Contains | ″foo″ | String, List, | Strings −> Bool |
| | | contains | Set, Expression | List, Expression −> |
| | | ″f″ | | Bool |
| | | | | Set, Expression −> |
| | | | | Bool |

Set Operators

Set Operators use prefix notation. They operate on sets and return a set. The table below lists the set operators that the IEL provides and shows their syntax.

| | Oper- | Exam- | | Result |
|---|---|---|---|---|
| Operation | ator | ple | Operand Types | Type |
| Union | union | union s1 s2 | Sets | Set |
| Intersection | intersect | intersect s1 s2 | Sets | Set |
| Difference | difference | difference s1 s2 | Sets | Set |
| Complement | complement | complement s1 s2 | Sets | Set |

List Operators

List Operators also use prefix notation. Currently, the only defined IEL binary list operator is cons. The cons operator takes an expression as its first operand and a list as its second operand. It then prepends the expression to the list. The first operand is now the head of the list. For example, if we define these facts:

myHead=“foo”

myTail=‘(“bar” “baz” “qux”)

myList=cons myHead myTail

then our output looks like this:

[myHead=“foo”]

[myList=[“foo”; “bar”; “baz”; “qux”]]

[myTail=[“bar”; “baz”; “qux”]]

The table below provides further information about cons.

| | Oper- | Exam- | | Result |
|---|---|---|---|---|
| Operation | ator | ple | Operand Types | Type |
| Cons | cons | cons ″foo″ | Expression, List | Expression, List −> |
| | | ′( ) | | List |

Unary Operator Expressions

Unary operator expressions use operators that require only one operand (thus, unary). These are always written using prefix notation. The table below illustrates their general syntax in the IEL.

| Syntax | Example |
|---|---|
| <operator> <expression> | not (x > 3) |

Arithmetic Negative

It is important to note that there is no arithmetic negative operator. Traditionally the—symbol is overloaded to provide negative, but in the IEL, the—symbol is reserved for binary subtraction. Of course, you can have a negative integer or float value, just not a negative variable. For example

bar=5

baz=−7

foo=bar*foo

provides these facts

[bar=5]

[baz=−7]

[foo=−35]

But if we try to write

qux=−bar*baz

we get a parse error. The best workaround is to multiply by negative 1:

qux=−1.0*bar*baz

[bar=5]

[baz=−7]

[foo=−35]

[qux=35]

Logical Operators

Currently, the IEL provides a single logical operator, logical negation. Of course, this operates on a Bool and results in a Bool. The table below shows its usage.

| | Oper- | Exam- | | Result |
|---|---|---|---|---|
| Operation | ator | ple | Operand Type | Type |
| Logical negation | not | not (x == false) | Bool | Bool |

Bitwise Operators

At this time, the IEL provides a single bitwise operator, bitwise negation. This operates on a decimal Integer and returns a decimal Integer since the IEL does not represent Integers in any other numeral system. Internally, Integers are interpreted as 32-bit, two's complement values. So ˜0=−1, ˜50=−51, or in general, ˜n=−(n+1). The table below shows syntax for bitwise negation.

| Operation | Operator | Example | Operand Type | Result Type |
|---|---|---|---|---|
| Bitwise negation | ~ | ~1 | Integer | Integer |

String Operators

Unary string operators take strings as input and return strings as output. The table below shows their usage.

| | Oper- | Exam- | | Result |
|---|---|---|---|---|
| Operation | ator | ple | Operand Type | Type |
| Convert to | toUpper | toUpper ″foo″ | String | String |
| Upper Case | | | | |
| Convert to | toLower | toLower ″FOO″ | String | String |
| Lower Case | | | | |
| Trim | trim | trim ″foo″ | String | String |
| Trim Start | trimStart | trimStart ″foo″ | String | String |
| Trim End | trimEnd | trimEnd ″foo″ | String | String |

List Operators

There are three unary list operators: isEmpty, head, and tail. The isEmpty returns False if a list contains any elements, and True otherwise. The head operator returns the first expression in a list, and tail returns the whole list except for the first expression. The table below shows their syntax.

| Operation | Operator | Example | Operand Type | Result Type |
|---|---|---|---|---|
| Is Empty | isEmpty | isEmpty myList | List | Bool |
| Head | head | head ′ (1 2 3) | List | Expression |
| Tail | tail | tail ′ (1 2 3) | List | List |

If Expressions

If expressions allow for conditional logic within the IEL. If expressions can be formatted with or without an else clause. The table below illustrates their general syntax.

Syntax

if <cond-expression> then <true-expression> else <false-expression> end
if <cond-expression> then <true-expression> end

Note that <cond-expression> must evaluate to True or False. However, the <true-expression> and <false-expression> may be any valid IEL expression. Of course, don't forget to end each of your If statements with end.

Here are some examples of If statements within the Interactive IEL Interpreter. Using If statements within facts can be a little contorting since facts must evaluate to assignment expressions:

foo=5

bar=if (foo==10) then 100 else 0 end

Current facts are:

[bar=0]

[foo=5]

That was fairly trivial. Now try If in a rule expression. Remember that rules must evaluate to True or False.

if (foo==5) then false else true end

Also trivial, and it is “Evaluated to value False of Bool”. Try

if (foo==5) then (bar>10) else true end

That also gets “Evaluated to value False of Bool”. Let's add the fact baz=20 and make a more complicated rule.

if (foo==5) then (if (baz>100) then false else true end) else false end

This nested If expression is “Evaluated to value True of Bool”.

Begin Expressions

Begin expressions are containers for other expressions. Expressions inside a begin are evaluated in the order they appear. The result of the begin expression is the result of the last expression inside it. You can create and use assignment expressions within a begin statement, but any identifiers you define in a begin statement only exist for the scope of that statement; they will not be persisted upon leaving the begin.

The table below illustrates the syntax of begin expressions. Note that expressions within the begin are separated by spaces. Remember to use parentheses to avoid ambiguity of expressions.

| Syntax | Example |
|---|---|
| begin { <expression-1> <expression-2> ... } | begin {x=1 y=2 z=false x} |

Here are some examples of Begin expressions and their results in the Interactive IEL Interpreter.

foo=begin {x=1 y=2 z=x+y x}

Current facts are:

[foo=1]

foo=begin {x=1 y=2 z=x+y}

Current facts are:

[foo=null]

Recall that the result of an assignment expression is null.

foo=begin {1 5 false “string” ‘(0 1 2 3 4) 3}

Current facts are:

[foo=3]

foo=begin {1 5 false “string” ‘(0 1 2 3 4)}

Current facts are:

[foo=[0; 1; 2; . . . ]]

Detailed Description of the Design Database

The most appropriate method for describing the design database is to list its SQL schema: Please refer to Listing 1.

The advantages of the present invention include, without limitation: a) it dramatically simplifies the process of creating a computer program, especially programs targeting mixed processor technology systems, b) it enables an individual without specific skills in computer programming or any specific programming language to create computer programs, c) it enables an individual without specific knowledge of the program execution hardware or environment to create suitable computer programs, d) it promotes the use of intellectual property reuse, e) it improves the protection of intellectual property, f) it reduces the cost of developing computer programs, and g) it reduces the time needed to create a computer program.

In broad embodiment, the present invention is a packaged application program (computer program) that executes in any compatible computer system.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We hereby claim the following invention:

1. A method and system for automated computer program generation comprising:
A graphical user interface that provides a method for defining, capturing, and storing visual representations of the desired computer program functionality and computational component interconnectivity.
Visual user interface elements that provide a user experience equivalent to rendering a process diagram on a whiteboard (chalkboard) and annotating the diagram elements with movable sticky notes.
A detailed ontology for representation, automated recognition, and automated processing of human expertise and knowledge as it relates to the creation and/or modification of a computer program.
A computer language for detailing the steps and decisions used by a human computer programming expert for automated processing and generation of the desired computer program.
A relational database of structured knowledge expressed in the above mentioned computer language and using the above mentioned ontology to provide the knowledge needed by the system to generate the desired computer program from the requirements defined using the above mentioned graphical user interface and visual user interface elements.
An artificial intelligence system that emulates the analytical process of one or more human experts to create a generic computer program from user requirements referencing the knowledge stored in the above mentioned relational database.
An expert system that emulates the decision-making process of one or more human experts in adapting a generic computer program defined by the above mentioned artificial intelligence for use on a user defined target (execution) system crafted in a user defined programming language.
A procedural system that organizes the output of the above mentioned expert system and prepares it for compilation and synthesis by user defined external tools.
